(19) United States
(12) Patent Application Publication
(10) Pub. No.: US 2024/0199054 A1
(43) Pub. Date: Jun. 20, 2024

(54) CONTROL DEVICE, CONTROL METHOD, AND STORAGE MEDIUM

(71) Applicant: HONDA MOTOR CO., LTD., Tokyo (JP)

(72) Inventors: Gaku SHIMAMOTO, Tokyo (JP); Jumpei NOGUCHI, Tokyo (JP); Ayumu MITOMO, Tokyo (JP); Miyuki SHIMOTA, Tokyo (JP)

(73) Assignee: HONDA MOTOR CO., LTD., Tokyo (JP)

(21) Appl. No.: 18/535,457

(22) Filed: Dec. 11, 2023

(30) Foreign Application Priority Data
Dec. 14, 2022 (JP) 2022-199418

(51) Int. Cl. B60W 50/14; B60W 30/06; B60W 50/023

(52) U.S. Cl. CPC B60W 50/14; B60W 30/06; B60W 50/023; G06F 3/0484

(57) ABSTRACT

A control device of a moving body, the control device includes: a communication unit configured to communicate with an information terminal portable by a user of the moving body; a movement control unit configured to perform movement control on the moving body based on a movement control instruction from the information terminal; a positional relationship determination unit configured to determine a relative positional relationship between the information terminal and the moving body; and a reception control unit configured to restrict reception of the movement control instruction from the information terminal in response to the positional relationship satisfying a predetermined condition.

This application is based upon and claims the benefit of priority from prior Japanese patent application No. 2022-199418, filed on Dec. 14, 2022, the entire contents of which are incorporated herein by reference.

### TECHNICAL FIELD

The present disclosure relates to a control device, a control method, and a storage medium storing a storage medium storing a control program.

### BACKGROUND ART

In recent years, efforts have been actively made to provide access to a sustainable transportation system in consideration of vulnerable people among traffic participants. In order to implement the above, focus has been placed on research and development on further improving safety and convenience of traffic by research and development related to driving assistance technique.

In the related art, there has been known a remote parking system that remotely operates a vehicle to park in a designated predetermined parking space or to cause the vehicle to exit from the parking space. A vehicle including a main power supply device (secondary battery) that supplies electric power to vehicle electrical components during normal vehicle traveling or during vehicle parking control, and an auxiliary power supply (capacitor) that supplies electric power to a safety device that decelerates or stops the vehicle when the main power supply device fails. JP2022-041514A describes a vehicle control device in which when an abnormality occurs in a first power supply device while parking assistance control is being executed, electric power is supplied from a second power supply device to a braking device and a shift switching device, and when an electric power storage amount of the second power supply device is monitored and the electric power storage amount becomes smaller than a predetermined value, the vehicle is stopped by controlling the braking device and the shift switching device.

### SUMMARY

When remote parking control of a vehicle is performed, a position of a user with respect to the vehicle at which the user gives the control instruction varies depending on the user. As long as remote communication with the vehicle is possible, a location of the user who gives the control instruction is not particularly limited. Therefore, for example, there may be a case where a control instruction of the vehicle is executed in a situation in which the user cannot sufficiently recognize an environment around the vehicle. Further, in the vehicle including the second power supply device (capacitor), the user may continue the control instruction of the vehicle regardless of a power storage status of the second power supply device. However, JP2022-041514A does not describe a position of a user who gives a control instruction of a vehicle with respect to the vehicle or a communication status with the vehicle. Therefore, there is room for improvement in the remote parking control of the vehicle in a positional relationship between the vehicle and the user.

Aspects of embodiments of the present disclosure relates to providing a control device, a control method, and a storage medium storing a control program capable of appropriately restricting movement control on a moving body from an outside.

According to an aspect of the present disclosure, there is provided a control device of a moving body, the control device including:

a communication unit configured to communicate with an information terminal portable by a user of the moving body:

a movement control unit configured to perform movement control on the moving body based on a movement control instruction from the information terminal:

a positional relationship determination unit configured to determine a relative positional relationship between the information terminal and the moving body: and

a reception control unit configured to restrict reception of the movement control instruction from the information terminal in response to the positional relationship satisfying a predetermined condition.

According to another aspect of the present disclosure, there is provided a control method performed by a control device, the control device including a processor, a communication unit configured to communicate with an information terminal portable by a user of a moving body and a movement control unit configured to perform movement control on the moving body based on a movement control instruction from the information terminal, the control method including

determining, by the processor, a relative positional relationship between the information terminal and the moving body, and

restricts, by the processor, reception of the movement control instruction from the information terminal in response to the positional relationship satisfying a predetermined condition.

According to another aspect of the present disclosure, there is provided a non-transitory computer readable storage medium storing a control program for causing a processor of a control device to execute a process, the control device including a communication unit configured to communicate with an information terminal portable by a user of a moving body and a movement control unit configured to perform movement control on the moving body based on a movement control instruction from the information terminal, the process including:

determining a relative positional relationship between the information terminal and the moving body, and

restricting reception of the movement control instruction from the information terminal in response to the positional relationship satisfying a predetermined condition.

According to the present disclosure, it is possible to provide a control device, a control method, and a storage medium storing a control program capable of appropriately restricting movement control on a moving body from an outside. Accordingly, the present disclosure may contribute to development of a sustainable transportation system.

### BRIEF DESCRIPTION OF DRAWINGS

Exemplary embodiment(s) of the present invention will be described in detail based on the following figures, wherein:

FIG. 1 is a side view showing an example of a vehicle whose movement is controlled by a control device according to the present embodiment:

FIG. 2 is a top view of the vehicle shown in FIG. 1:

FIG. 3 is a block diagram showing an internal configuration of the vehicle shown in FIG. 1;

FIG. 4 is a diagram showing an example of a hardware configuration of an information terminal:

FIG. 5 is a diagram showing how movement of the vehicle is controlled using the information terminal from an outside of the vehicle:

FIG. 6 is a flowchart of exit control of a calculation unit at the time of automatic exit of the vehicle:

FIG. 7 is a flowchart showing the exit control of the calculation unit following processing of FIG. 6:

FIG. 8 is a sequence diagram showing a first operation example of a control system:

FIG. 9 is a sequence diagram showing a second operation example of the control system:

FIG. 10 is a reception screen displayed on the information terminal during the processing of communication connection between the vehicle and the information terminal in the automatic exit of the vehicle;

FIG. 11 is a reception screen displayed on the information terminal when the communication connection between the vehicle and the information terminal is completed:

FIG. 12 is a reception screen displayed on the information terminal when an ignition ON instruction is to be received:

FIG. 13 is a reception screen displayed on the information terminal when an ignition ON button is pressed:

FIG. 14 is a reception screen displayed on the information terminal when the ignition ON button is pressed and the vehicle is started:

FIG. 15 is a reception screen displayed on the information terminal when an action plan of the vehicle is to be received:

FIG. 16 is a reception screen displayed on the information terminal when the action plan of the vehicle is received:

FIG. 17 is a charge wait screen displayed on the information terminal when waiting for charging a sub-power supply: and

FIG. 18 is a reception screen displayed on the information terminal when a movement control execution instruction by the user is to be received.

### DESCRIPTION OF EMBODIMENTS

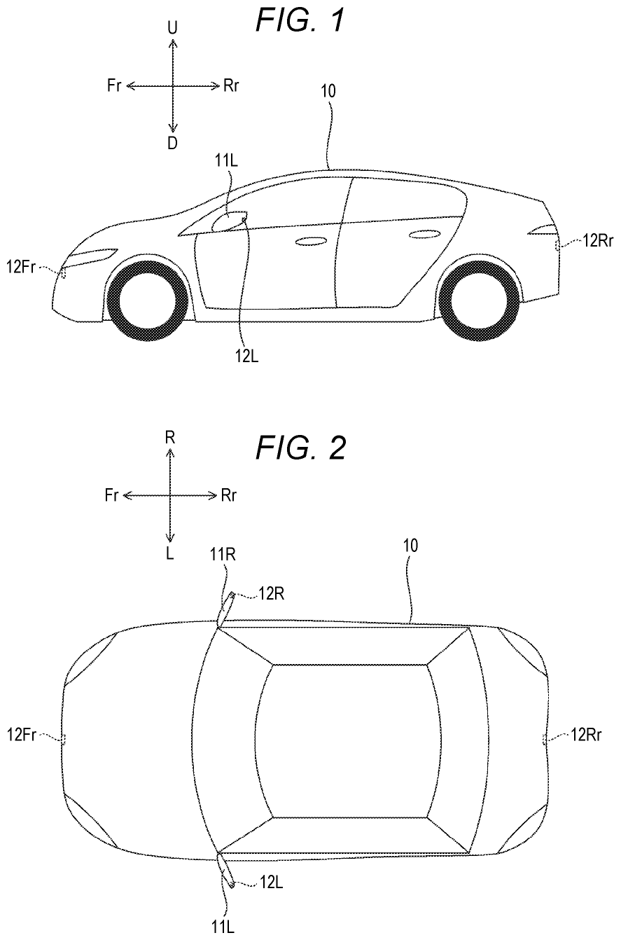

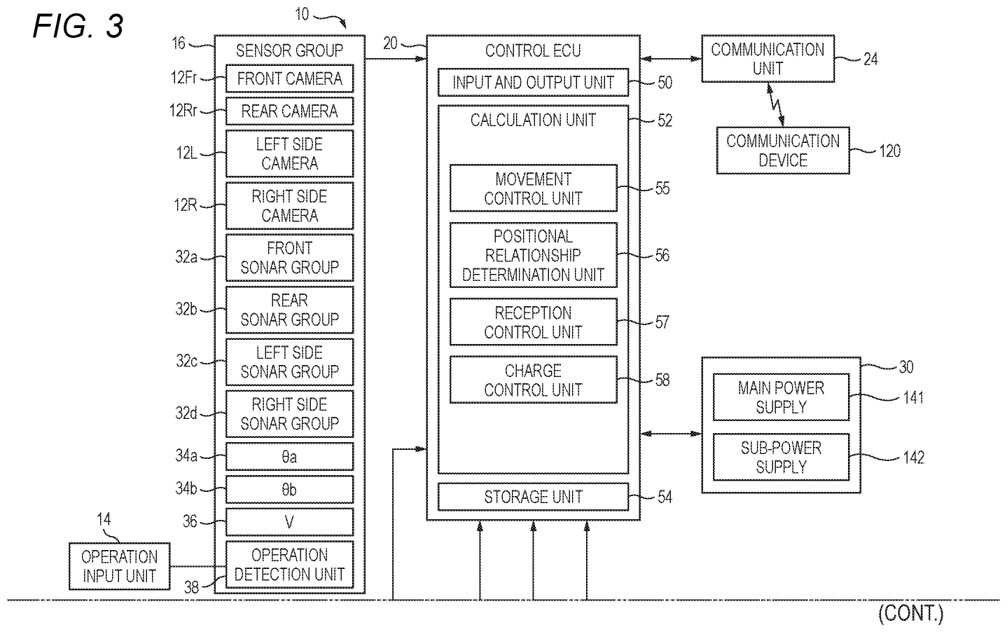

Hereinafter, an embodiment of a control device, a control method, and a storage medium storing a control program of the present disclosure will be described with reference to the attached drawings. The drawings are viewed from directions of reference numerals. Further, in the present specification and the like, in order to simplify and clarify the description, a front-rear direction, a left-right direction, and an upper-lower direction are described according to directions viewed from a driver of a vehicle 10 shown in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

### Vehicle 10 Whose Movement is Controlled by Control Device

FIG. 1 is a side view showing the vehicle 10 whose movement is controlled by a control device according to the present disclosure. FIG. 2 is a top view of the vehicle 10 shown in FIG. 1. The vehicle 10 is an example of a moving body in the present disclosure.

The vehicle 10 is an automobile including a drive source (not shown), and wheels including drive wheels driven by power of the drive source and steerable wheels. In the present embodiment, the vehicle 10 is a four-wheeled automobile including a pair of left and right front wheels and a pair of left and right rear wheels. The drive source of the vehicle 10 is, for example, an electric motor. The drive source of the vehicle 10 may be an internal combustion engine such as a gasoline engine or a diesel engine, or may be a combination of an electric motor and an internal combustion engine. The drive source of the vehicle 10 may drive the pair of left and right front wheels, the pair of left and right rear wheels, or the four wheels including the pair of left and right front wheels and the pair of left and right rear wheels. Both the front wheels and the rear wheels may be the steerable driven wheels, or either one of the front wheels and the rear wheels may be the steerable wheels.

The vehicle 10 further includes side mirrors 11L and 11R. The side mirrors 11L and 11R are mirrors (back mirrors) that are provided on outer sides of front seat doors of the vehicle 10 and that are for a driver to check a rear side and rear lateral sides. Each of the side mirrors 11L and 11R is fixed to a main body of the vehicle 10 by a rotation shaft that extends in a perpendicular direction, and may be opened and closed by being rotated around the rotation shaft.

The vehicle 10 further includes a front camera 12Fr, a rear camera 12Rr, a left side camera 12L, and a right side camera 12R. The front camera 12Fr is a digital camera that is provided at a front portion of the vehicle 10 and that images the front side of the vehicle 10. The rear camera 12Rr is a digital camera that is provided at a rear portion of the vehicle 10 and that images the rear side of the vehicle 10. The left side camera 12L is a digital camera that is provided at a left side mirror 11L of the vehicle 10 and that images the left side of the vehicle 10. The right side camera 12R is a digital camera that is provided at a right side mirror 11R of the vehicle 10 and that images the right side of the vehicle 10.

### Internal Configuration of Vehicle 10

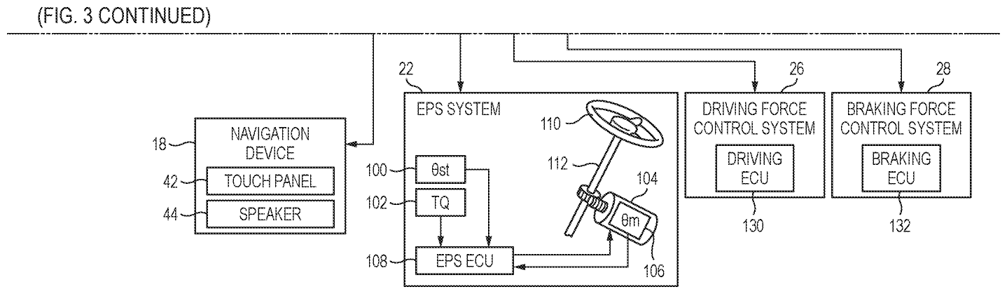

FIG. 3 is a block diagram showing an example of an internal configuration of the vehicle 10 shown in FIG. 1. As shown in FIG. 3, the vehicle 10 includes a sensor group 16, a navigation device 18, a control electronic control unit (ECU) 20, an electric power steering (EPS) system 22, and a communication unit 24. The vehicle 10 further includes a driving force control system 26, a braking force control system 28, and a power supply 30.

The sensor group 16 acquires various detection values used for control performed by the control ECU 20. The sensor group 16 includes the front camera 12Fr, the rear camera 12Rr, the left side camera 12L, and the right side camera 12R. Further, the sensor group 16 includes a front sonar group 32a, a rear sonar group 32b, a left side sonar group 32c, and a right side sonar group 32d. Further, the sensor group 16 includes wheel sensors 34a and 34b, a vehicle speed sensor 36, and an operation detection unit 38. The sensor group 16 may include a radar.

The front camera 12Fr, the rear camera 12Rr, the left side camera 12L, and the right side camera 12R acquire recognition data (for example, surrounding images) for recognizing external environment of the vehicle 10 by imaging surroundings of the vehicle 10. Surrounding images captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image.

The front sonar group 32a, the rear sonar group 32b, the left side sonar group 32c, and the right side sonar group 32d emit sound waves to the surroundings of the vehicle 10, and receive reflected sounds from other objects. The front sonar group 32a includes, for example, four sonars. The sonars that constitute the front sonar group 32a are provided on an obliquely left front side, a front left side, a front right side, and an obliquely right front side of the vehicle 10, respectively. The rear sonar group 32b includes, for example, four sonars. The sonars that constitute the rear sonar group 32b are provided on an obliquely left rear side, a rear left side, a rear right side, and an obliquely right rear side of the vehicle 10, respectively. The left side sonar group 32c includes, for example, two sonars. The sonars that constitute the left side sonar group 32c are provided at a left side front portion and a left side rear portion of the vehicle 10, respectively: The right side sonar group 32d includes, for example, two sonars. The sonars that constitute the right side sonar group 32d are respectively provided at a right side front portion and a right side rear portion of the vehicle 10.

The wheel sensors 34a and 34b detect rotation angles of the wheels of the vehicle 10. The wheel sensors 34a and 34b may be implemented by angle sensors, or may be implemented by displacement sensors. The wheel sensors 34a and 34b output detection pulses every time the wheels are rotated by a predetermined angle. The detection pulses output from the wheel sensors 34a and 34b are used for calculating rotation angles of the wheels and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a countershaft of a transmission.

The operation detection unit 38 detects operation content of a user performed using an operation input unit 14, and outputs the detected operation content to the control ECU 20. The operation input unit 14 includes various user interfaces such as a side mirror switch for switching between open and closed states of the side mirrors 11L and 11R, and a shift lever (selector lever or selector).

The navigation device 18 detects a current position of the vehicle 10 by using, for example, a global positioning system (GPS), and guides the user to a path to a destination. The navigation device 18 includes a storage device (not shown) including a map information database.

The navigation device 18 includes a touch panel 42 and a speaker 44. The touch panel 42 functions as an input device and a display device of the control ECU 20. The speaker 44 outputs various types of guidance information to the user of the vehicle 10 by voice.

The touch panel 42 is configured such that various commands to the control ECU 20 is input via the touch panel 42. For example, the user may input a command related to movement assistance of the vehicle 10 via the touch panel 42. The movement assistance includes parking assistance and exit assistance of the vehicle 10. Further, the touch panel 42 is configured to display various screens related to control content of the control ECU 20. For example, a screen related to the movement assistance of the vehicle 10 is displayed on the touch panel 42. Specifically, a parking assistance button for requesting the parking assistance and an exit assistance button for requesting the exit assistance of the vehicle 10 are displayed on the touch panel 42. The parking assistance button includes an automatic parking button for requesting parking by automatic steering of the control ECU 20, and a guidance parking button for requesting guidance during parking by an operation of the driver. The exit assistance button includes an automatic exit button for requesting exit by the automatic steering of the control ECU 20 and a guidance exit button for requesting guidance when the exit of the vehicle is performed by an operation of the driver. Constituent elements other than the touch panel 42, for example, a smartphone or a tablet terminal may be used as the input device or the display device.

The power supply 30 includes a main power supply 141 and a sub-power supply 142. The main power supply 141 is a power supply (secondary power supply) that supplies electric power to an electronic device installed in the vehicle 10 when the vehicle 10 is normally traveling and when the vehicle 10 is parked or exits. The sub-power supply 142 is a power supply (auxiliary power supply) that supplies electric power to vehicle stability assist (VSA) and electric parking brake (EPB) that decelerate or stop the vehicle 10 when the main power supply 141 fails. The sub-power supply 142 is used to operate fail-safe by operating VSA and EPB. The main power supply 141 is, for example, a lithium ion battery, a nickel-metal hydride battery, or a lead-acid battery. The sub-power supply 142 is, for example, a capacitor (electric double-layer capacitor). The power supply 30 is connected to the control ECU 20. The sub-power supply 142 is a power supply device in the present disclosure.

The control ECU 20 includes an input and output unit 50, a calculation unit 52, and a storage unit 54. The calculation unit 52 is implemented by, for example, a central processing unit (CPU). The calculation unit 52 performs various kinds of control by controlling units based on a program stored in the storage unit 54. Further, the calculation unit 52 inputs and outputs a signal from and to each unit connected to the control ECU 20 via the input and output unit 50. The control ECU 20, the calculation unit 52, or a combination of these and the communication unit 24 is an example of the control device in the present disclosure.

The calculation unit 52 includes a movement control unit 55 that performs movement control on the vehicle 10, a positional relationship determination unit 56 that determines a positional relationship between the vehicle 10 and an information terminal that may be carried by the user, a reception control unit 57 that restricts reception of a movement control instruction, and a charge control unit 58 that performs charge control on the sub-power supply 142.

The movement control unit 55 performs automatic parking assistance and automatic exit assistance of the vehicle 10 by automatic steering in which an operation of a steering wheel 110 is automatically performed under the control of the movement control unit 55. In the automatic parking assistance and the automatic exit assistance, an accelerator pedal (not shown), a brake pedal (not shown), and the operation input unit 14 are automatically operated. The movement control unit 55 performs auxiliary parking assistance and auxiliary exit assistance 30) when the driver operates the accelerator pedal, the brake pedal, and the operation input unit 14 to manually park and manually cause the vehicle 10 to perform exit.

For example, the movement control unit 55 performs the movement control for executing movement of the vehicle 10 based on the recognition data of the external environment of the vehicle 10 acquired by the front camera 12Fr, the rear camera 12Rr, the left side camera 12L, and the right side camera 12R, and a parking space designated by the user. The movement control includes parking control for automatically parking the vehicle 10 in a predetermined parking space and exit control for causing the vehicle 10 to automatically exit from the predetermined parking space to a target movement position. The movement control unit 55 executes the parking control and the exit control according to instruction signals input from the outside via the input and output unit 50. The input from the outside includes an input via wireless communication from an information terminal or the like carried by the user of the vehicle 10. The movement control unit 55 transmits information related to the parking control and the exit control to an external information terminal via the input and output unit 50.

The movement control unit 55 registers the predetermined parking space designated by the user in the storage unit 54 as a designated parking space. The movement control unit 55 registers feature points related to the designated parking space in the storage unit 54 based on the recognition data of the external environment of the vehicle 10 acquired by the front camera 12Fr, the rear camera 12Rr, the left side camera 12L, and the right side camera 12R. The movement control unit 55 performs the automatic parking control for parking the vehicle 10 in the designated parking space and the automatic exit control for exiting from the designated parking space based on the recognition data of the external environment of the vehicle 10 and the feature points of the designated parking space designated by the user.

The positional relationship determination unit 56 determines a relative positional relationship between the information terminal carried by the user and the vehicle 10. The positional relationship between the information terminal carried by the user and the vehicle 10 includes, for example, a positional relationship between the information terminal and the vehicle 10 at a mutual distance (equal to or greater than a predetermined value), a positional relationship in which a shield that interferes with mutual communication is sandwiched between the information terminal and the vehicle 10, and the like. The shield is, for example, an object that blocks a field of view from the position of the information terminal to the vehicle 10. However, a transparent object such as an acrylic plate, a fence, and the like may be excluded from the shield. Whether the shield is sandwiched between the information terminal and the vehicle 10 may be determined by, for example, using a camera of the vehicle 10 based on whether the position of the information terminal can be seen by the camera. The position of the information terminal may be specified by, for example, determining by positioning of the information terminal which is a communicable information terminal using Bluetooth Low Energy (BLE (registered trademark)). Whether the shield is sandwiched between the information terminal and the vehicle 10 may be determined based on, for example, a distance from the vehicle 10 to the information terminal and a radio wave intensity between the information terminal and the vehicle 10 with respect to the distance. In addition, the presence or absence of the shield may be determined by analyzing an image captured by a camera to calculate a shielding degree in a direction (angle of view) of the information terminal, or calculating a shielding degree based on a spatial sensor, and comparing the shielding degree with a threshold.

The relative positional relationship may include not only a positional relationship between a current position of the vehicle 10 and the information terminal carried by the user, but also a positional relationship between a position of a movement destination of the vehicle 10 whose movement is controlled and the information terminal carried by the user. For example, the relative positional relationship may include whether the position of the movement destination of the vehicle 10 is seen from the user carrying the information terminal.

When the positional relationship between the information terminal carried by the user and the vehicle 10 satisfies a predetermined condition, the reception control unit 57 restricts reception of the movement control instruction from the information terminal. The movement control instruction is an operation of the information terminal for selecting or determining an exit direction of the vehicle 10 in order to cause the vehicle 10 to automatically exit from the predetermined parking space to the target movement position. Restricting the reception of the movement control instruction means controlling the information terminal to restrict the reception of the instruction. For example, the restriction on the reception of the instruction includes not displaying a reception screen on a terminal screen of the information terminal, graying out the reception screen, and not receiving the operation (not reacting) even when the reception screen is touched.

When the positional relationship between the information terminal carried by the user and the vehicle 10 does not satisfy the predetermined condition, for example, when the distance between the information terminal and the vehicle 10 is smaller than the predetermined value or when there is no shield between the information terminal and the vehicle 10, the reception control unit 57 displays, on the information terminal of the user, a first display image for receiving the movement control instruction. On the other hand, when the positional relationship between the information terminal carried by the user and the vehicle 10 satisfies the predetermined condition, for example, when the distance between the information terminal and the vehicle 10 is equal to or greater than the predetermined value, or when there is a shield between the information terminal and the vehicle 10, the display of the first display image on the information terminal of the user is restricted. The first display image is, for example, an image for receiving an action plan of the movement control. The action plan of the movement control includes, for example, designating a direction (exit direction) in which the vehicle 10 is to be moved.

When the positional relationship between the information terminal carried by the user and the vehicle 10 satisfies the predetermined condition, the reception control unit 57 performs notification for prompting the user to move the position where the user is present. For example, the reception control unit 57 displays, on the information terminal, a second display image for prompting the user to move so as to eliminate a state in which the positional relationship satisfies the predetermined condition. Eliminating the state satisfying the predetermined condition includes, for example, elimination by the approach of the user carrying the information terminal to the vehicle 10 and elimination by the movement to the position avoiding the shield. The second display image may be, for example, message information such as “please approach the vehicle”, “please move to a place where the vehicle can be seen”, “restriction is released when avoiding a shield”, or “restriction is released when approaching the vehicle”. For example, the reception control unit 57 may perform notification by outputting the message from the information terminal by voice, or by outputting the message by voice from the vehicle 10.

When the positional relationship between the information terminal carried by the user and the vehicle 10 does not satisfy the predetermined condition after the reception of the movement control instruction from the information terminal is restricted, for example, when the distance between the information terminal and the vehicle 10 becomes smaller than the predetermined value or when there is no longer any shields between the information terminal and the vehicle 10, the reception control unit 57 releases the restriction on the reception. Releasing the restriction means displaying the first display image for receiving the movement control instruction on the information terminal of the user.

The reception control unit 57 sets the predetermined condition of the positional relationship between the information terminal carried by the user and the vehicle 10 in 30) accordance with a surrounding environment of the vehicle 10. The surrounding environment includes, for example, weather and brightness around the vehicle 10, and a regional difference. The regional difference is, for example, a difference between a city with poor visibility due to many obstacles and countryside with good visibility. Setting the predetermined condition in accordance with the surrounding environment means, for example, setting the predetermined condition such that it is easier to be satisfied in an environment where it is more difficult to view the vehicle 10. For example, in the environment where the vehicle 10 is more difficult to be viewed, the reception control unit 57 restricts the reception of the movement control instruction even at a smaller distance between the information terminal and the vehicle 10. In addition, for example, in the environment where the vehicle 10 is more difficult to be viewed, the reception control unit 57 restricts the reception of the movement control instruction even at a lower shielding degree.

After receiving the movement control instruction from the information terminal, the reception control unit 57 displays a third display image for starting the movement control on the information terminal. The third display image may be, for example, an image for continuously swiping the terminal screen of the information terminal or an image for rotating and swiping the terminal screen in a predetermined rotation direction.

For example, the reception control unit 57 displays a fourth display image for starting the vehicle 10 on the terminal screen of the information terminal. The fourth display image is, for example, an image of “ignition ON button”, and text information of “please press the power button”.

When the vehicle 10 is started in response to an instruction of the user on the fourth display image, the charge control unit 58 starts the charge control on the sub-power supply 142 for the movement control on the vehicle 10.

When the positional relationship between the information terminal carried by the user and the vehicle 10 does not satisfy the predetermined condition after the start of the charge control on the sub-power supply 142, the reception control unit 57 displays the first display image for receiving the movement control instruction on the terminal screen of the information terminal. The movement control instruction includes, for example, designation of a direction in which the vehicle 10 is to be moved. When a progress state of the charge control on the sub-power supply 142 does not reach a predetermined state after the movement control instruction is received in response to an instruction of the user on the first display image, the reception control unit 57 displays a fifth display image representing the progress state of the charge 30) control on the terminal screen of the information terminal. In addition, when the progress state of the sub-power supply 142 reaches the predetermined state after the movement control instruction is received in response to the instruction of the user on the first display image, the reception control unit 57 does not display the fifth display image on the terminal screen of the information terminal, or displays the fifth display image on the terminal screen of the information terminal in a less noticeable manner than a case where the progress state does not reach the predetermined state. After the progress state of the charge control on the sub-power supply 142 reaches the predetermined state, the reception control unit 57 displays the third display image for receiving the movement control instruction of the vehicle 10 on the terminal screen of the information terminal.

The progress state includes at least any one of a progress rate of the charge control, a time until the charge control is completed, a charge amount of the sub-power supply 142, and a charge rate of the sub-power supply 142. The fifth display image may be, for example, an image indicating a time until the completion of the charge control such as “Preparing for remote exit. It will take up to xx seconds” or an image of a progress bar indicating a progress state of the charge. The progress bar may indicate, for example, a current progress state with a progress state at a start time of the charge control on the sub-power supply 142 as a starting point. The progress bar may indicate a current progress state with a progress state at a start time of the display of the fifth display image as a starting point, for example.

The progress state is a ratio of a current elapsed time to a time required for the charge control on the sub-power supply 142. For example, when the time required for the charge control (the time until the charge is completed) is 10 seconds, the progress bar indicating the progress state is displayed such that the progress bar extends (progresses) at a constant speed during the 10 seconds. The time required for the charge control may be fixed at 20 seconds, for example, or may be predicted in consideration of a remaining charge amount, an environmental temperature, and a degree of deterioration. Regarding the starting point of the progress bar, the progress state at the start time of the charge control as described above may be set as the starting point, or the progress state at the start time of displaying the fifth display image may be set as the starting point.

The movement control unit 55 restricts the movement control on the vehicle 10 when at least any one of the sub-power supply 142 and the charge control on the sub-power supply 142 is abnormal. For example, in a case where the charge control on the sub-power supply 142 takes 20 seconds or more, or in a case where the sub-power supply 142 can only be charged 30) below: 80%, it is determined that the battery is deteriorated, and the movement control on the vehicle 10 is restricted. The restriction on the movement control includes, for example, not allowing the vehicle 10 to be remotely parked anyway, shortening a travelable distance and a travelable range of the vehicle 10 in the remote parking, and slowing down a movement speed of the vehicle 10 in the remote parking. In a case where a battery of the sub-power supply 142 completely fails, the ignition may be turned off and the user may be notified of this matter. Even when the battery of the sub-power supply 142 completely fails, the movement control may be performed under allowance of the user.

The EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby enabling the occupant to perform operation assistance of the steering 110 and automatic steering during the parking assistance. The resolver 106 detects a rotation angle θm of the EPS motor 104. The EPS ECU 108 controls the entire EPS system 22. The EPS ECU 108 includes an input and output unit (not shown), a calculation unit (not shown), and a storage unit (not shown).

The communication unit 24 may perform wireless communication with another communication device 120. Another communication device 120 is a base station, a communication device of another vehicle, or an information terminal such as a smartphone or a tablet terminal that is portable for a user of the vehicle 10. For example, the communication unit 24 has an ultra wide band (UWB (registered trademark)) interface for performing UWB communication with an information terminal. The information terminal will be described later.

The driving force control system 26 includes a driving ECU 130. The driving force control system 26 executes driving force control of the vehicle 10. The driving ECU 130 controls a driving force of the vehicle 10 by controlling an engine or the like (not shown) based on an operation performed by the user on the accelerator pedal (not shown).

The braking force control system 28 includes a braking ECU 132. The braking force control system 28 executes braking force control of the vehicle 10. The braking ECU 132 controls a braking force of the vehicle 10 by controlling a braking mechanism or the like (not shown) based on an operation performed by the user on the brake pedal (not shown).

### Hardware Configuration of Information Terminal

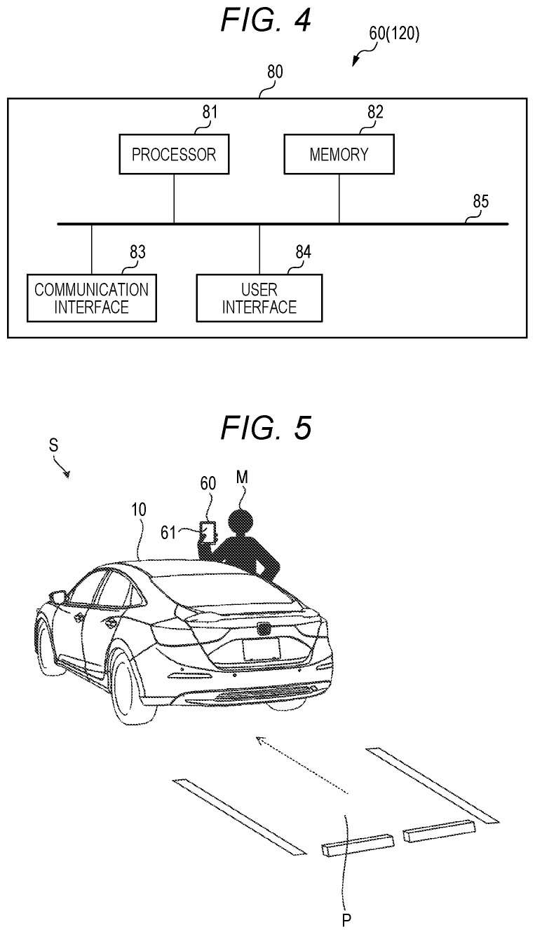

FIG. 4 is a diagram showing an example of a hardware configuration of an information terminal 60. Hardware of the information terminal 60 may be implemented by, for example, an information processing device 80 shown in FIG. 4. The information processing device 80 includes a processor 81, a memory 82, a communication interface 83, and a user interface 84. The processor 81, the memory 82, the communication interface 83, and the user interface 84 are connected by, for example, a bus 85.

The processor 81 is a circuit that performs signal processing, and is, for example, a central processing unit (CPU) that controls the entire information processing device 80. The processor 81 may be implemented by another digital circuit such as a field programmable gate array (FPGA) or a digital signal processor (DSP). In addition, the processor 81 may be implemented by combining a plurality of digital circuits.

The memory 82 includes, for example, a main memory and an auxiliary memory. The main memory is, for example, a random access memory (RAM). The main memory is used as a work area of the processor 81.

The auxiliary memory is, for example, a nonvolatile memory such as a magnetic disk, an optical disk, or a flash memory. Various programs for causing the information processing device 80 to operate are stored in the auxiliary memory. The programs stored in the auxiliary memory are loaded onto the main memory and executed by the processor 81.

In addition, the auxiliary memory may include a portable memory removable from the information processing device 80. Examples of the portable memory include a universal serial bus (USB) flash drive, a memory card such as a secure digital (SD) memory card, and an external hard disk drive.

The communication interface 83 is a communication interface that performs the wireless communication with an outside of the information processing device 80 (for example, the communication unit 24 of the vehicle 10). For example, the communication interface 83 has a UWB interface for UWB communication with the vehicle 10. The communication interface 83 is controlled by the processor 81.

The user interface 84 includes, for example, an input device that receives an operation input from the user and an output device that outputs information to the user. The input device may be implemented by, for example, a touch panel. The output device may be implemented by, for example, a display and a speaker. The user interface 84 is controlled by the processor 81.

The processor 81 performs the movement control for giving an instruction to move the vehicle 10. For example, the processor 81 performs the movement control on the vehicle 10 based on a specific operation of the user on the terminal screen of the information terminal 60. The movement control includes, for example, the parking control for automatically parking the vehicle 10 in a predetermined parking space and the exit control for causing the vehicle 10 to automatically exit from the predetermined parking space to a target movement position. The specific operation includes, for example, a slide operation for moving the vehicle 10, and a tap operation for reserving parking and exit plans. The slide operation includes a continuous position instruction operation (for example, swiping operation), a rotation instruction operation in a predetermined rotation direction (for example, rotation swiping operation), and the like. Further, the processor 81 performs control of generating a guidance image for prompting the user to perform an instruction operation on the terminal screen of the information terminal 60 and displaying the generated guidance image on the terminal screen.

Specifically, the processor 81 displays, on the terminal screen of the information terminal 60, the fourth display image for starting the vehicle 10. Based on the operation of the user on the fourth display image, the processor 81 causes the calculation unit 52 of the vehicle 10 to start the vehicle 10 and start the charge control on the sub-power supply 142. When the vehicle 10 is started, the processor 81 displays the first display image for receiving the movement control instruction of the vehicle 10 on the terminal screen of the information terminal 60. The processor 81 receives the action plan (exit direction of the vehicle 10) of the movement control on the vehicle 10 based on the operation of the user on the first display image. The processor 81 displays, on the terminal screen of the information terminal 60, the second display image for prompting the user to move so as to eliminate the state in which the positional relationship between the information terminal 60 carried by the user and the vehicle 10 satisfies the predetermined condition. After receiving the movement control instruction, the processor 81 displays the third display image for starting the movement control on the terminal screen of the information terminal 60. After receiving the movement control instruction, the processor 81 displays the fifth display image on the terminal screen of the information terminal 60 according to the progress state of the charge control on the sub-power supply 142.

The processor 81 transmits to the vehicle 10 a parking instruction for automatically parking the vehicle 10 and an exit instruction for causing the vehicle 10 to automatically exit based on a specific operation on the third display image displayed on the terminal screen of the information terminal 60. An application capable of controlling the movement of the vehicle 10 by transmitting and receiving information related to the movement control on the vehicle 10 to and from the vehicle 10 is installed in the information terminal 60.

### Control Performed by Information Terminal 60

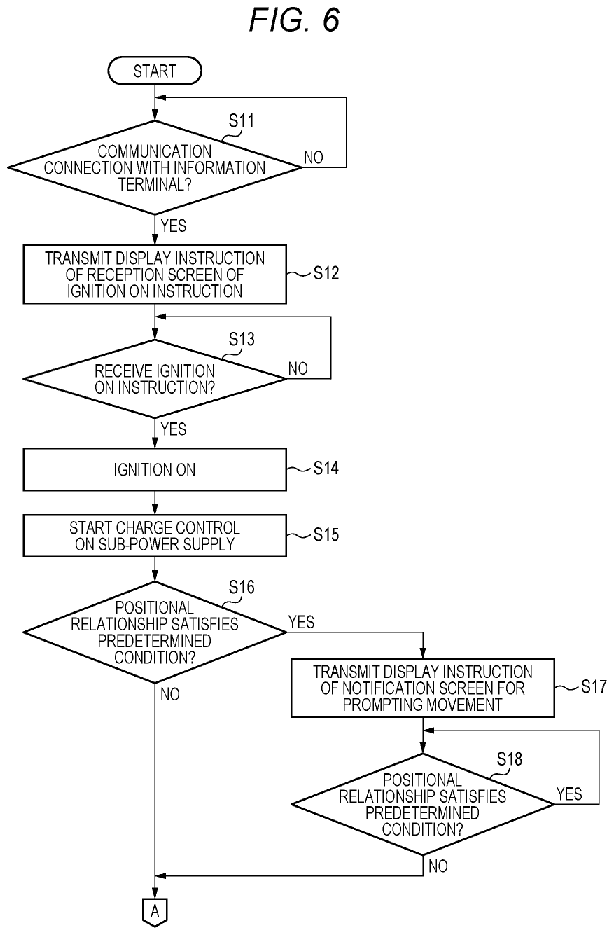

FIG. 5 shows an example of how a user M of the vehicle 10 performs the movement instruction control for causing the vehicle 10 to automatically exit from a parking space P using the information terminal 60 carried by the user M outside the vehicle 10. The movement instruction control includes, for example, exit instruction control for causing the vehicle 10 to automatically exit from the parking space P and parking instruction control for causing the vehicle 10 to automatically park in the parking space P. The example shown in FIG. 5 shows how the vehicle 10 is controlled to give an instruction to exit.

When a terminal screen 61 implemented as a touch panel is touched, the information terminal 60 transmits to the vehicle 10 an instruction signal to give an instruction of automatic exit of the vehicle 10 by the wireless communication. As the wireless communication with the vehicle 10, for example, UWB, BLE, Near Field Communication (NFC (registered trademark)), or the like is used. The vehicle 10 receives the instruction signal from the information terminal 60 through the communication unit 24. The movement control unit 55 of the vehicle 10 performs the exit control for causing the vehicle 10 to automatically exit according to the received instruction signal.

### Movement Control of Vehicle 10 Performed by Calculation Unit 52

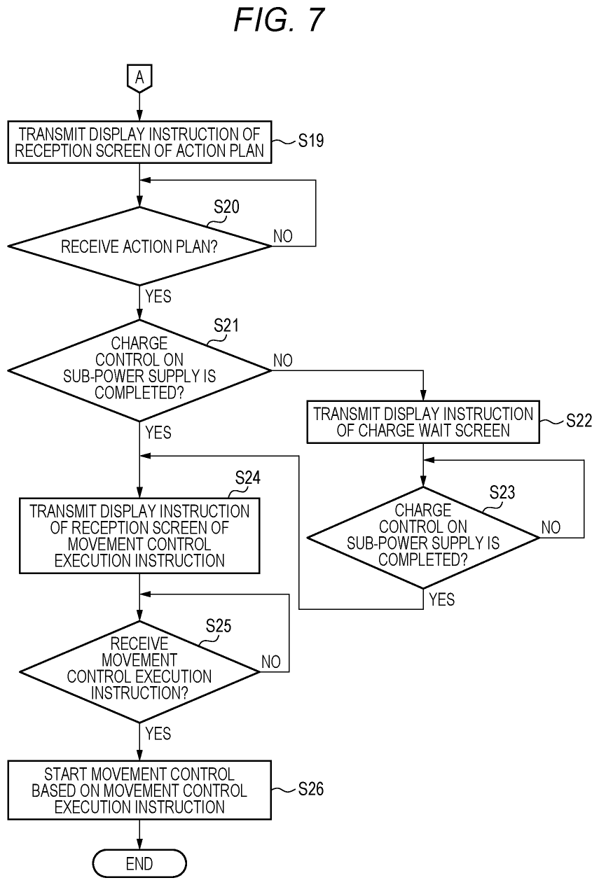

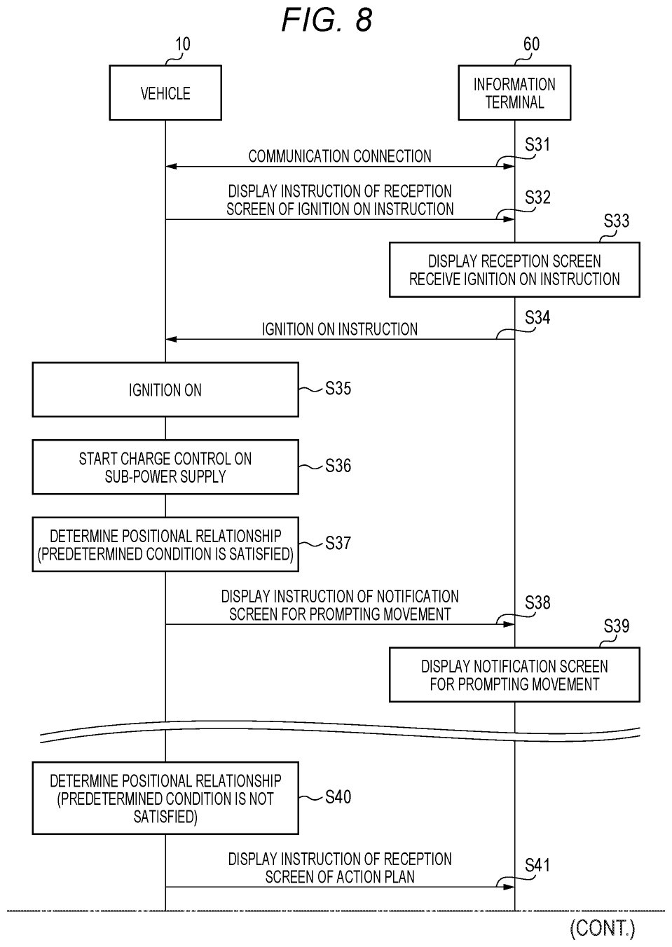

Next, the movement control of the vehicle 10 performed by the calculation unit 52 of the vehicle 10 will be described with reference to FIGS. 6 and 7.

FIG. 6 is a flowchart showing the exit control of the calculation unit 52 at the time of automatic exit of the vehicle 10. FIG. 7 is a flowchart showing the exit control of the calculation unit 52 following processing shown in FIG. 6. The exit control of the present example is executed, for example, in a situation as shown in FIG. 5 in which the user M is intended to cause the vehicle 10 to automatically exit from the parking space P using the information terminal 60.

First, the calculation unit 52 determines whether the vehicle 10 is connected to the information terminal 60 by the wireless communication (step S11). The communication connection is enabled by transmitting a connection request from the information terminal 60 to the vehicle 10.

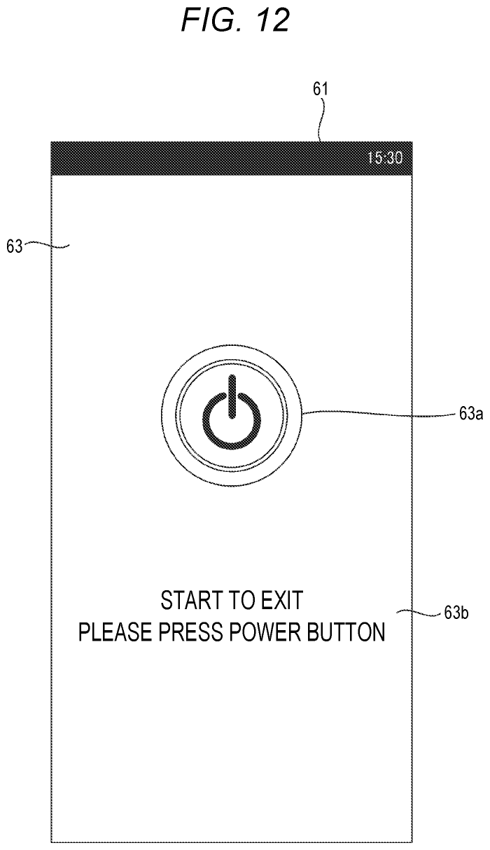

In step S11, in a case where the communication connection with the information terminal 60 is not established (step S11: No), the calculation unit 52 repeats the processing of step S11 and waits until the communication connection is established. In step S11, in a case where the communication connection with the information terminal 60 is established (step S11: Yes), the calculation unit 52 transmits a display instruction to the information terminal 60 (step S12) in order to display, on the terminal screen 61 of the information terminal 60, a reception screen of an ignition ON instruction for turning on an ignition of the vehicle 10. The reception screen of the ignition ON instruction is an example of the fourth display image in the present disclosure. An example of the reception screen of the ignition ON instruction is the screen shown in FIG. 12. The processing of step S12 is executed by the reception control unit 57 of the calculation unit 52.

Next, the calculation unit 52 determines whether the ignition ON instruction for turning on the ignition of the vehicle 10 is received from the information terminal 60 (step S13).

In step S13, in a case where the ignition ON instruction is not received (step S13: No), the calculation unit 52 repeats the processing of step S13 until the ignition ON instruction is received. In step S13, in a case where the ignition ON instruction is received (step S13: Yes), the calculation unit 52 turns on the ignition of the vehicle 10 (step S14).

Next, the calculation unit 52 starts the charge control for charging the battery of the sub-power supply 142 of the vehicle 10 (step S15). The processing of step S15 is executed by the charge control unit 58 of the calculation unit 52.

Next, the calculation unit 52 determines whether the positional relationship between the information terminal 60 carried by the user M and the vehicle 10 satisfies a predetermined condition (step S16). As described above, the positional relationship of the predetermined condition is a positional relationship in which the distance between the information terminal 60 and the vehicle 10 is equal to or greater than a predetermined value, a positional relationship in which a shield that interferes with mutual communication is sandwiched between the information terminal and the vehicle 10, or the like. The processing of step S16 is executed by the positional relationship determination unit 56 of the calculation unit 52.

In step S16, in a case where the positional relationship satisfies the predetermined condition, for example, in a case where the distance between the information terminal 60 and the vehicle 10 is equal to or greater than the predetermined value (step S16: Yes), the calculation unit 52 transmits a display instruction to the information terminal 60 in order to display, on the terminal screen 61 of the information terminal 60, a notification screen for prompting the user M to move to eliminate the state in which the predetermined condition is satisfied (step S17). As described above, the notification screen for prompting movement is a screen in which message information such as “please approach the vehicle” and “please move to a place where the vehicle can be seen” is displayed. The notification screen for prompting movement is an example of the second display image of the present disclosure. The processing of step S17 is executed by the reception control unit 57 of the calculation unit 52.

Next, the calculation unit 52 determines again whether the positional relationship between the information terminal 60 carried by the user M and the vehicle 10 satisfies a predetermined condition (step S18).

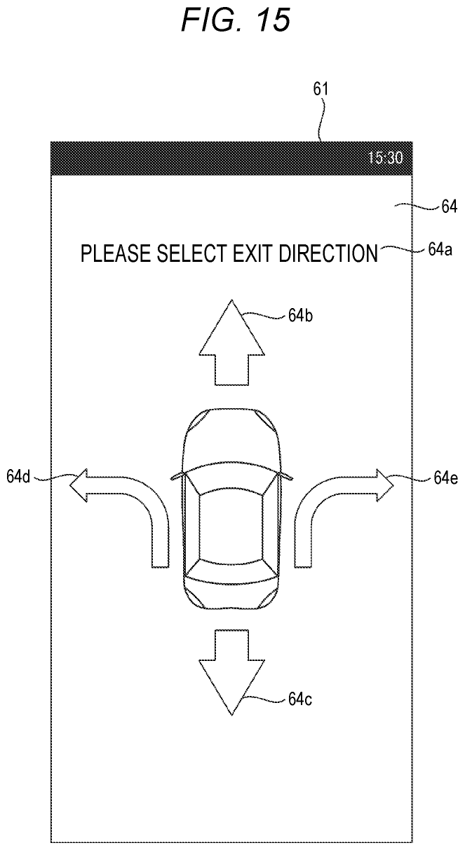

In step S18, when the positional relationship satisfies the predetermined condition (step S18: Yes), the calculation unit 52 repeats the processing of step S18. Accordingly, the calculation unit 52 restricts the progress of the movement control. In step S18, in a case where the positional relationship no longer satisfies the predetermined condition (that is, in a case where the predetermined condition is eliminated) (step S18: No), the processing proceeds to FIG. 7, and the calculation unit 52 transmits a display instruction to the information terminal 60 in order to display; on the terminal screen 61 of the information terminal 60, a reception screen of an action plan for causing the user M to perform an input operation of an action plan (exit direction) of the vehicle 10 (step S19). Accordingly, the calculation unit 52 releases the restriction on the progress of the movement control. The reception screen of the action plan is an example of the first display image in the present disclosure. An example of the reception screen of the action plan is the screen shown in FIG. 15. The processing of step S19 is executed by the reception control unit 57 of the calculation unit 52.

On the other hand, in step S16, in a case where the positional relationship does not satisfy the predetermined condition (step S16: No), the calculation unit 52 proceeds to step S19, and transmits a display instruction to the information terminal 60 in order to display the reception screen of the action plan on the terminal screen 61 of the information terminal 60.

Next, the calculation unit 52 determines whether the action plan of the vehicle 10 is received from the information terminal 60 by which the display instruction is transmitted in step S19 (step S20).

In step S20, in a case where the action plan is not received (step S20: No), the calculation unit 52 repeats the processing of step S20 until the action plan is received. In step S20, in a case where the action plan is received (step S20: Yes), the calculation unit 52 determines whether the charge control on the sub-power supply 142 started in step S15 is completed (step S21).

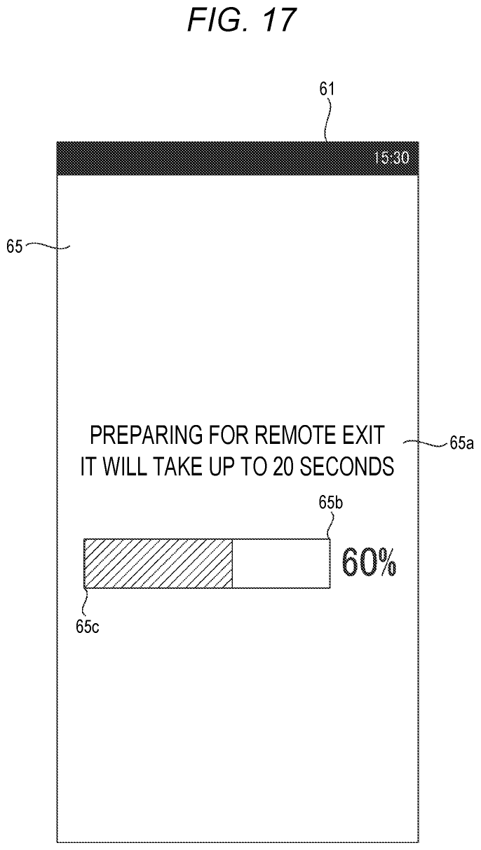

In step S21, in a case where the charge control on the sub-power supply 142 is not completed (step S21: No), in order to display, on the terminal screen 61 of the information terminal 60, a charge wait screen for making the user M wait for charge complete of the sub-power supply 142, the calculation unit 52 transmits a display instruction to the information terminal 60 (step S22). The charge wait screen is an example of the fifth display image in the present disclosure. An example of the charge wait screen is the screen shown in FIG. 17. The processing of step S22 is executed by the reception control unit 57 of the calculation unit 52.

Next, the calculation unit 52 determines again whether the charge control on the sub-power supply 142 is completed (step S23).

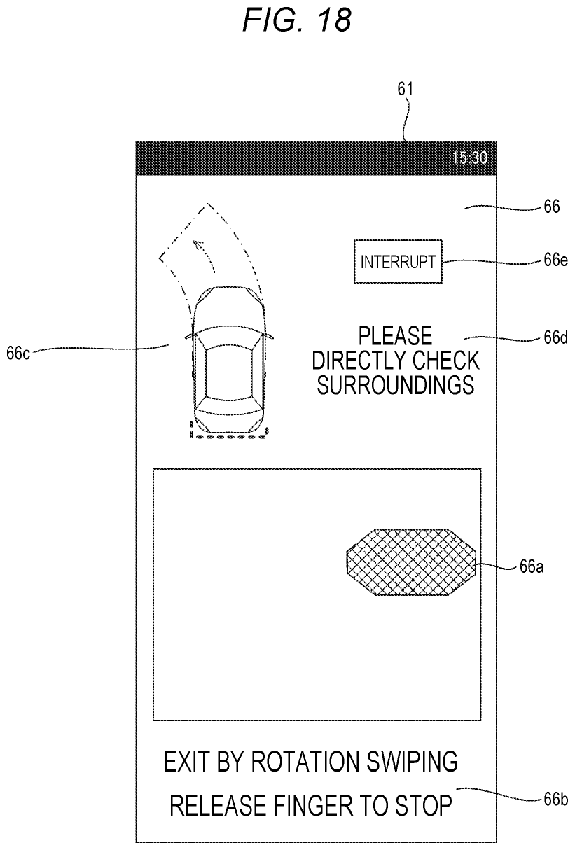

In step S23, in a case where the charge control on the sub-power supply 142 is not completed (step S23: No), the calculation unit 52 repeats the processing of step S23 until the charge control is completed. In step S23, in a case where the charge control on the sub-power supply 142 is completed (step S23: Yes), in order to display; on the terminal screen 61 of the information terminal 60, a reception screen of a movement control execution instruction for allowing the user M to give an instruction to execute the movement control on the vehicle 10, the calculation unit 52 transmits a display instruction to the information terminal 60 (step S24). The reception screen of the movement control execution instruction is an example of the third display image in the present disclosure. An example of the reception screen of the movement control execution instruction is the screen shown in FIG. 18. The processing of step S24 is executed by the reception control unit 57 of the calculation unit 52.

On the other hand, in a case where it is determined in step S21 that the charge control on the sub-power supply 142 is completed (step S21: Yes), the calculation unit 52 also proceeds to step S24, and transmits the display instruction of the reception screen of the movement control execution instruction to the information terminal 60.

Next, the calculation unit 52 determines whether the movement control execution instruction is received from the information terminal 60 that transmits the display instruction in step S24 (step S25).

In step S25, in a case where the movement control execution instruction is not received (step S25: No), the calculation unit 52 repeats the processing of step S25 until the movement control execution instruction is received. In step S25, in a case where the movement control execution instruction is received (step S25: Yes), the calculation unit 52 starts the movement control on the vehicle 10 based on the movement control execution instruction (step S26).

As described above, the control device (calculation unit 52) of the vehicle 10 determines the relative positional relationship between the information terminal 60 and the vehicle 10. In a case where the positional relationship satisfies the predetermined condition, for example, in a case where the user M carrying the information terminal 60 is at a position away from the vehicle 10 by a predetermined distance or more or in a case where a shield is present between the user M and the vehicle 10, the control device (calculation unit 52) of the vehicle 10 restricts the reception of the instruction from the information terminal 60 when the movement control on the vehicle 10 is performed by the information terminal 60. Therefore, it is possible to prevent a situation in which the movement control on the vehicle 10 based on the instruction from the information terminal 60 of the user M is performed in a situation in which the safety of the surrounding environment of the moving body cannot be sufficiently confirmed by the user M since the distance to the vehicle 10 is long or a shield exists between the vehicle and the user M. Accordingly, it is possible to appropriately restrict the movement control on the vehicle 10 from the outside of the vehicle 10.

When the relative positional relationship between the information terminal 60 and the vehicle 10 satisfies the predetermined condition, the calculation unit 52 displays, on the information terminal 60, a display image for prompting the user M to move to eliminate the state in which the predetermined condition is satisfied, for example, message information such as “please approach the vehicle”. Therefore, it is possible to prevent a situation in which the movement control on the vehicle 10 is performed although the safety of the surrounding environment of the moving body cannot be sufficiently confirmed. In addition, it is possible to cause the user M to recognize why reception of an instruction from the information terminal 60 is restricted. In a case where the relative positional relationship between the information terminal 60 and the vehicle 10 no longer satisfies the predetermined condition after the reception of the instruction from the information terminal 60 is restricted, the calculation unit 52 releases the restriction on the reception. Accordingly, it is possible to appropriately restrict the movement control on the vehicle 10 from the outside of the vehicle 10. In addition, it is possible to eliminate an anxiety of the user about not receiving the instruction from the information terminal 60.

### Operation of Control System

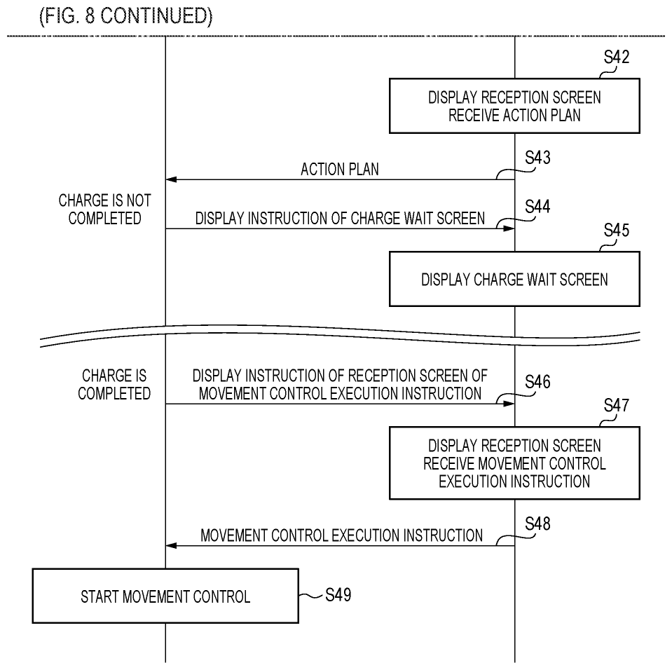

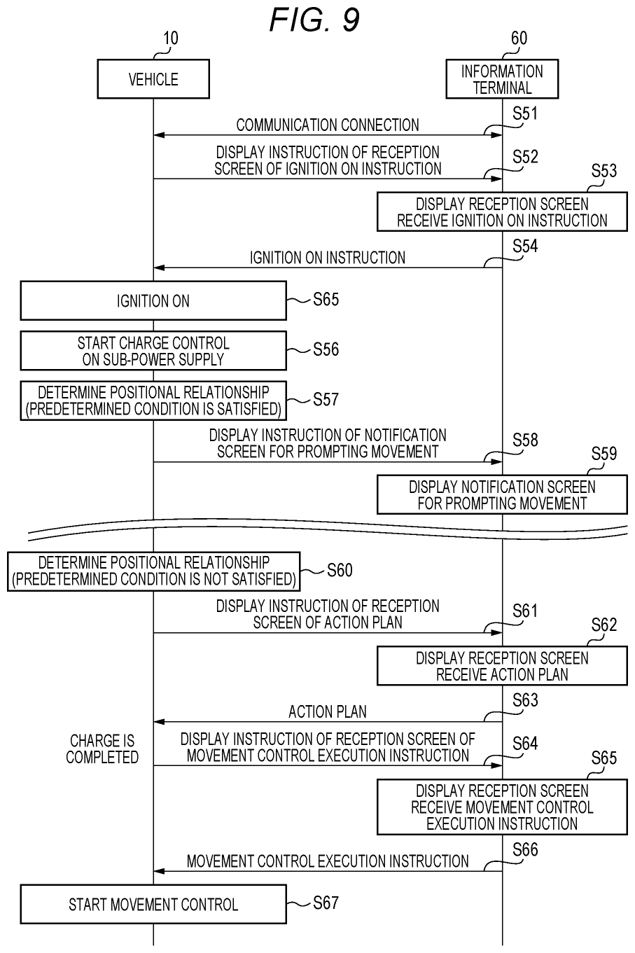

Next, an operation example of a control system S (see FIG. 5) including the vehicle 10 that performs the automatic exit control and the information terminal 60 that performs the exit instruction control will be described with reference to FIGS. 8 and 9. As shown in FIG. 5, this operation example is executed in a situation in which the user M intends to use the information terminal 60 to cause the vehicle 10 to automatically exit from the parking space P.

### First Operation Example

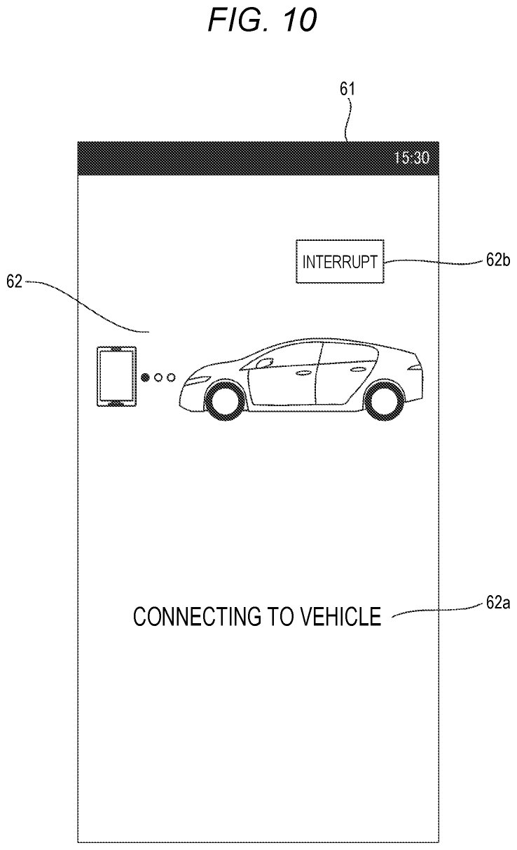

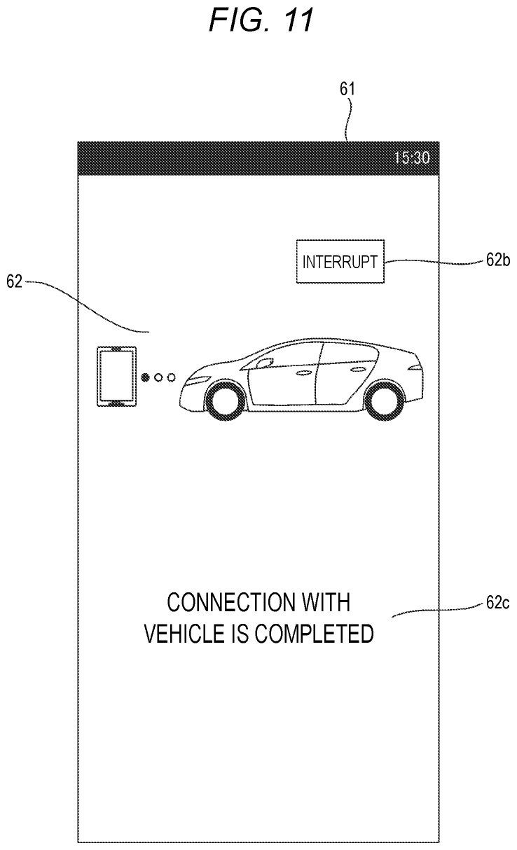

FIG. 8 is a sequence diagram showing a first operation example of the control system S. The information terminal 60 activates an automatic exit application, and transmits a communication connection request to the vehicle 10. The vehicle 10 receives the communication connection request from the information terminal 60, so that the vehicle 10 and the information terminal 60 are connected to each other and become communicable with each other (step S31). At this time, examples of the screen displayed on the terminal screen 61 of the information terminal 60 are reception screens shown in FIGS. 10 and 11.

Next, in order to display, on the terminal screen 61 of the information terminal 60, the reception screen of the ignition ON instruction for the operation to turn on the ignition of the vehicle 10, the vehicle 10 transmits the display instruction to the information terminal 60 (step S32).

Next, the information terminal 60 displays on the terminal screen 61 the reception screen of the ignition ON instruction according to the display instruction received from the vehicle 10, and receives the ignition ON instruction from the user M on the reception screen (step S33). Examples of the reception screen of the ignition ON instruction are the screens shown in FIGS. 12 to 14.

Next, in response to receiving the ON instruction from the user M, the information terminal 60 transmits the ignition ON instruction for turning on the ignition to the vehicle 10 (step S34).

Next, in response to receiving the ignition ON instruction from the information terminal 60, the vehicle 10 turns on the ignition of the vehicle 10 (step S35).

Next, the vehicle 10 starts the charge control for charging the battery of the sub-power supply 142 of the vehicle 10 (step S36).

Next, the vehicle 10 determines whether the positional relationship between the information terminal 60 carried by the user M and the vehicle 10 satisfies the predetermined condition (step S37). As described above, the positional relationship satisfying the predetermined condition is a positional relationship in which the distance between the information terminal 60 and the vehicle 10 is equal to or greater than a predetermined value, a positional relationship in which a shield that interferes with mutual communication is sandwiched between the information terminal 60 and the vehicle 10, or the like.

Next, when the positional relationship between the information terminal 60 carried by the user M and the vehicle 10 satisfies the predetermined condition, the vehicle 10 transmits a display instruction to the information terminal 60 in order to display, on the terminal screen 61 of the information terminal 60, a notification screen for prompting the user M to move to eliminate the state in which the predetermined condition is satisfied (step S38). When the positional relationship between the information terminal 60 and the vehicle 10 satisfies the predetermined condition, the vehicle 10 restricts reception of an automatic exit instruction from the information terminal 60.

Next, the information terminal 60 displays the notification screen for prompting movement on the terminal screen 61 according to the display instruction received from the vehicle 10 (step S39). As described above, the notification screen for prompting movement is a screen of message information such as “please approach the vehicle” and “please move to a place where the vehicle can be seen”.

Next, the vehicle 10 determines again whether the positional relationship between the information terminal 60 carried by the user M and the vehicle 10 satisfies the predetermined condition (step S40).

Next, when the positional relationship between the information terminal 60 carried by the user M and the vehicle 10 no longer satisfies the predetermined condition (a state satisfying the predetermined condition is eliminated), the vehicle 10 transmits a display instruction to the information terminal 60 in order to display, on the terminal screen 61 of the information terminal 60, a reception screen of an action plan for causing the user M to perform an input operation of the action plan of the vehicle 10 (step S41). The vehicle 10 releases the restriction on the reception of the automatic exit instruction from the information terminal 60.

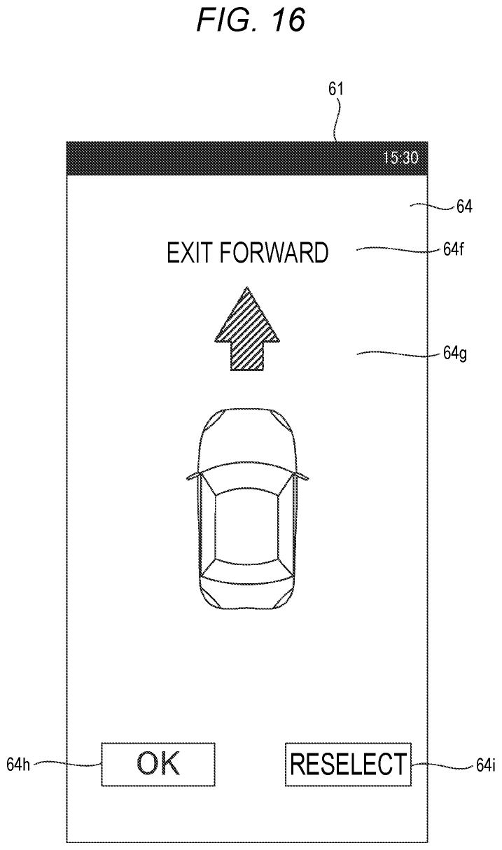

Next, the information terminal 60 displays on the terminal screen 61 the reception screen of the action plan according to the display instruction received from the vehicle 10, and receives an action plan instruction from the user M on the reception screen (step S42). An example of the reception screen of the action plan is the screen shown in FIG. 15, and an example of the screen for receiving the action plan instruction is the screen shown in FIG. 16.

Next, in response to receiving the action plan instruction from the user M, the information terminal 60 transmits the action plan to the vehicle 10 (step S43).

Next, in response to receiving the action plan from the information terminal 60, the vehicle 10 determines whether the charge control on the sub-power supply 142 started in step S36 is completed. In a case where the charge of the sub-power supply 142 is not yet completed, the vehicle 10 transmits the display instruction to the information terminal 60 (step S44) in order to display, on the terminal screen 61 of the information terminal 60, the charge wait screen for having the user M wait for charging.

Next, the information terminal 60 displays the charge wait screen on the terminal screen 61 according to the display instruction received from the vehicle 10 (step S45). An example of the charge wait screen is the screen shown in FIG. 17.

Next, after waiting for charging for a predetermined period, in a case where the charge of the sub-power supply 142 started in step S36 is completed, the vehicle 10 transmits the display instruction to the information terminal 60 (step S46) in order to display, on the terminal screen 61 of the information terminal 60, the reception screen of the movement control execution instruction for executing the movement control on the vehicle 10.

Next, the information terminal 60 displays the reception screen of the movement control execution instruction on the terminal screen 61 according to the display instruction received from the vehicle 10, and receives the movement control execution instruction from the user M on the reception screen (step S47). An example of the reception screen of the movement control execution instruction is the screen shown in FIG. 18.

Next, in response to receiving the movement control execution instruction from the user M, the information terminal 60 transmits the movement control execution instruction for executing the movement control to the vehicle 10 (step S48).

Next, the vehicle 10 starts the movement control for causing the vehicle 10 to automatically exit from the parking lot according to the movement control execution instruction received from the information terminal 60 (step S49).

### Second Operation Example

FIG. 9 is a sequence diagram showing a second operation example of the control system S. The second operation example is an operation example in a case where the exit control of vehicle 10 is performed by the vehicle 10 and the information terminal 60 which are communicably connected, similarly to the first operation example described in FIG. 8. In the first operation example, the charge of the sub-power supply 142 is not yet completed when the action plan is transmitted from the information terminal 60 to the vehicle 10. The second operation example differs from the first operation example in that the charge of the sub-power supply 142 is completed when the action plan is transmitted.

As shown in FIG. 9, in the second operation example, the processing from step S51 to step S63 is the same as the processing from step S31 to step S43 of the first operation example described in FIG. 8. Therefore, the description of steps S51 to S63 is omitted.

Next, in response to receiving the action plan from the information terminal 60 in step S63, the vehicle 10 determines whether the charge control on the sub-power supply 142 started in step S56 is completed. In a case where the charge of the sub-power supply 142 is completed, the vehicle 10 transmits the display instruction to the information terminal 60 (step S64) in order to display, on the terminal screen 61 of the information terminal 60, the reception screen of the movement control execution instruction for executing the movement control on the vehicle 10. That is, in a case where the charge of the sub-power supply 142 is completed when the vehicle 10 receives the action plan from the information terminal 60, the vehicle 10 does not display the charge wait screen for waiting for charge on the terminal screen 61 of the information terminal 60.

The processing from step S65 to step S67 is the same as the processing from step S47 to step S49 described in FIG. 8. Therefore, the description of steps S65 to S67 is omitted.

As described above, according to the first operation example and the second operation example of the control system S, the relative positional relationship between the information terminal 60) and the vehicle 10 is determined. In a case where the positional relationship satisfies the predetermined condition, the transmission of the movement control instruction from the information terminal 60 to the vehicle 10 is restricted, and the notification for prompting the user M to move is performed so as to eliminate the state in which the predetermined condition is satisfied. Therefore, it is possible to prevent a situation in which the movement control on the vehicle 10 based on the instruction from the information terminal 60 of the user M is performed in a situation in which the safety of the surrounding environment of the moving body cannot be sufficiently confirmed by the user M in a case where the distance to the vehicle 10 is long or in a case where a shield exists between the vehicle 10 and the user M, for example. In addition, it is possible to cause the user M carrying the information terminal 60 to recognize why reception of an instruction from the information terminal 60 is restricted. Accordingly, it is possible to appropriately restrict the movement control on the vehicle 10 from the outside of the vehicle 10.

According to the first operation example of the control system S, when the relative positional relationship between the information terminal 60 and the vehicle 10 does not satisfy the predetermined condition, the charge control on the sub-power supply 142 is performed while the action plan instruction of the vehicle 10 is received from the user M, and when the charge of the sub-power supply 142 is not completed after the action plan instruction is received, the charge wait screen is displayed on the information terminal 60. Therefore, the charge wait screen is not displayed on the information terminal 60 while the user Mis performing the action plan instruction related to the automatic exit of the vehicle 10, and thus, it may be possible to make the user M feel that the time to wait for the charge control on the sub-power supply 142 is short.

According to the second operation example of the control system S, when the relative positional relationship between the information terminal 60 and the vehicle 10 does not satisfy the predetermined condition, the charge control on the sub-power supply 142 is performed while the action plan instruction of the vehicle 10 is received from the user M, and when the charge of the sub-power supply 142 is completed after the action plan instruction is received, the charge wait screen is not displayed on the information terminal 60. Therefore, it is possible to reduce the user M's annoyance caused by the charge wait screen being displayed on the information terminal 60.

### Example of Image Displayed on Information Terminal

FIGS. 10 to 18 show an example of an image displayed on the terminal screen 61 of the information terminal 60 at the time of automatic exit of the vehicle 10.

FIG. 10 is a reception screen 62 displayed on the terminal screen 61 of the information terminal 60 during the processing of the communication connection between the vehicle 10 and the information terminal 60 in the automatic exit of the vehicle 10. The processor 81 displays the reception screen 62 on the terminal screen 61, for example, when the automatic exit application is activated. The processor 81 displays on the reception screen 62 a connection message 62a indicating that the information terminal 60 is in the process of connecting to the vehicle 10, such as “connecting to vehicle”, and an interruption button 62b for interrupting the connection processing.

FIG. 11 shows the reception screen 62 displayed on the terminal screen 61 of the information terminal 60 when the communication connection between the vehicle 10 and the information terminal 60 is completed. The processor 81 displays on the reception screen 62 a connection completion message 62c indicating that the connection processing between the information terminal 60 and the vehicle 10 is completed, such as “connection with the vehicle is completed”. The reception screen 62 of FIGS. 10 and 11 is, for example, a screen displayed in step S31 of FIG. 8 or step S51 of FIG. 9.

FIG. 12 is a reception screen 63 displayed on the terminal screen 61 of the information terminal 60 when the ignition ON instruction is to be received. The processor 81 displays on the reception screen 63 an ignition ON button 63a and a start message 63b for prompting the start of the vehicle 10, such as “Start to exit. Please press POWER button”.

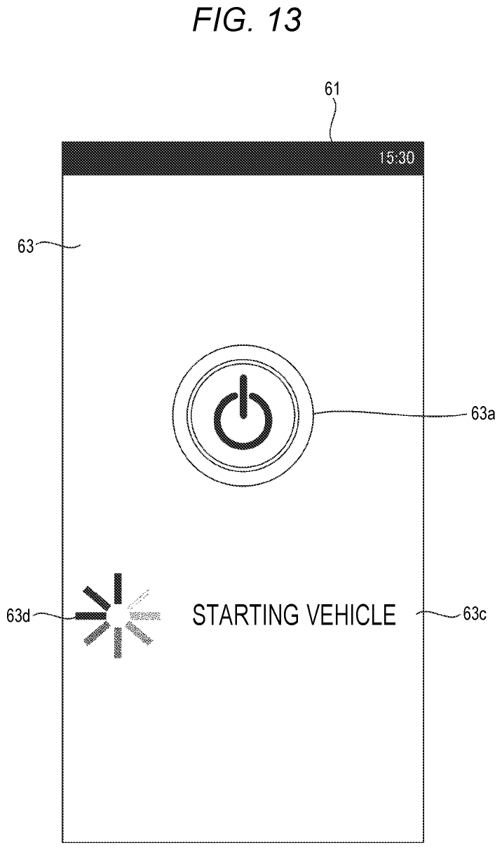

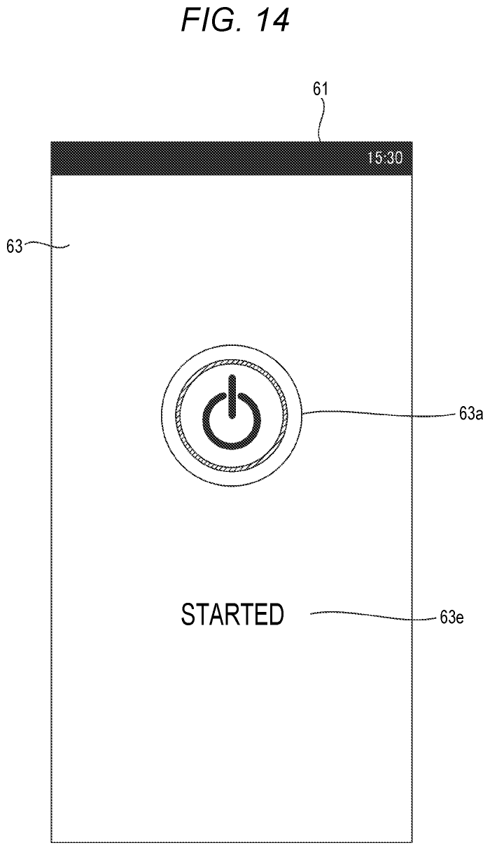

Each of FIGS. 13 and 14 is the reception screen 63 displayed on the terminal screen 61 of the information terminal 60 when the ignition ON button 63a is tapped. As shown in FIG. 13, the processor 81 displays on the reception screen 63 a start-up message 63c indicating that the vehicle 10 is being started, such as “starting the vehicle”, and a start-up mark 63d. As shown in FIG. 14, the processor 81 displays on the reception screen 63 a start completion message 63e indicating that the vehicle 10 is started such as “started”. The reception screen 63 of FIGS. 12 to 14 is, for example, a screen displayed in step S33 of FIG. 8 or step S53 of FIG. 9.

FIGS. 15 and 16 show a reception screen 64 displayed on the terminal screen 61 of the information terminal 60 when the action plan of the vehicle 10 is to be received. As shown in FIG. 15, at the start of the reception of the action plan, the processor 81 displays on the reception screen 64 a direction selection message 64a for prompting the selection of a direction for the exit of the vehicle 10, such as “please select exit direction”, and exit direction arrows 64b to 64e indicating exit directions of the vehicle 10. As shown in FIG. 16, when the action plan is received, the processor 81 displays on the reception screen 64 a direction confirmation message 64f such as “exit forward” indicating an exit direction selected by the user M, and a selected exit direction arrow 64g indicating the exit direction. Furthermore, the processor 81 displays on the reception screen 64 an OK button 64h for deciding the exit direction and a reselection button 64i for reselecting the exit direction. The reception screen 64 of FIGS. 15 and 16 is, for example, a screen displayed in step S42 of FIG. 8 or step S62 of FIG. 9.

FIG. 17 is a charge wait screen 65 displayed on the terminal screen 61 of the information terminal 60 when waiting for charging the sub-power supply 142. The processor 81 displays on the charge wait screen 65 a charge wait message 65a that gives a notification of waiting for charging the sub-power supply 142, such as “Preparing for remote exit. It will take up to 20 seconds”, and a progress bar 65b indicating the progress state of the charge. The charge wait message 65a shown in FIG. 17 indicates that the time until the charge control on the sub-power supply 142 is completed is 20 seconds. The progress bar 65b indicates that the charge progress rate of the sub-power supply 142 is currently 60%. The charge wait screen 65 of FIG. 17 is, for example, a screen displayed in step S45 of FIG. 8.

FIG. 18 is a reception screen 66 displayed on the terminal screen 61 of the information terminal 60) when the movement control execution instruction by the user M is to be received. The processor 81 displays on the reception screen 66 a movement icon 66a that moves following a touch position in a rotation swiping operation by the user M, for example. The processor 81 displays a guide message 66b for executing the automatic exit of the vehicle 10 or stopping the automatic exit of the vehicle 10, such as “exit by rotation swiping” or “release finger to stop”. The processor 81 displays an execution state image 66c indicating the execution state of the exit control for the vehicle 10 (how the vehicle moves) above a region where the movement icon 66a is displayed. Further, the processor 81 displays, on a right side of the execution state image 66c, a caution message 66d to alert the user M who performs the instruction operation, such as “please directly check surroundings”, and an interruption button 66e that interrupts the automatic exit control. The reception screen 66 of FIG. 18 is, for example, a screen displayed in step S47 of FIG. 8 or step S65 of FIG. 9. The processor 81 transmits the movement control execution instruction to the vehicle 10 when receiving a specific operation such as a continuous swiping operation by the user M on the reception screen 66, a rotation swiping operation in a predetermined rotation direction, and the like.

The control method described in the embodiment described above may be implemented by executing a control program prepared in advance by a computer. The present control program is recorded in a computer-readable storage medium and executed by being read from the storage medium. Further, the present control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that is communicable with the control device, or may be provided in a server device that is communicable with the control device and the electronic device.

The embodiment of the present disclosure has been described above, but the present disclosure is not limited to the embodiment described above, and modifications, improvements, and the like can be made as appropriate.

For example, in the above embodiment, an example in which the vehicle (four-wheeled automobile) is used as a moving body has been described, but the present disclosure is not limited thereto. For example, the vehicle may be a two-wheeled vehicle, a Segway, or the like. Furthermore, the idea of the present disclosure is not limited to vehicles, but may be applied to robots, ships, aircraft, and the like that are equipped with a drive source and can move by power of the drive source.

In the present specification, at least the following matters are described. Although corresponding constituent elements or the like in the above-described embodiment are shown in parentheses, the present disclosure is not limited thereto.

(1) A control device (calculation unit 52) of a moving body (vehicle 10), the control device including:
a communication unit (communication unit 24) configured to communicate with an information terminal portable by a user of the moving body;
a movement control unit (movement control unit 55) configured to perform movement control on the moving body based on a movement control instruction from the information terminal;
a positional relationship determination unit (positional relationship determination unit 56) configured to determine a relative positional relationship between the information terminal and the moving body: and
a reception control unit (reception control unit 57) configured to restrict reception of the movement control instruction from the information terminal in response to the positional relationship satisfying a predetermined condition.

According to (1), the relative positional relationship between the information terminal and the moving body is determined. In a case where the positional relationship satisfies a predetermined condition, the reception of an instruction from the information terminal when the movement control on the moving body is performed by the information terminal may be restricted, and thus the movement control on the moving body from the outside of the moving body may be appropriately restricted.

(2) The control device according to (1), in which
the predetermined condition includes a condition that is satisfied in response to a distance between the information terminal and the moving body being equal to or greater than a predetermined value.

According to (2), when the user carrying the information terminal is at a position away from the moving body by a predetermined distance or more, it is possible to restrict the reception of the movement control instruction from the information terminal. Therefore, it is possible to prevent a situation in which the movement control on the moving body is performed although the safety of the surrounding environment of the moving body cannot be sufficiently confirmed by the user.

(3) The control device according to (1) or (2), in which
the predetermined condition includes a condition that is satisfied in response to a shield being sandwiched between the information terminal and the moving body.

According to (3), when there is a shield between the user carrying the information terminal and the moving body, it is possible to restrict the reception of the movement control instruction from the information terminal. Accordingly, it is possible to prevent a situation in which the movement control on the moving body is performed although the safety of the surrounding environment of the moving body cannot be sufficiently confirmed by the user due to the shield.

(4) The control device according to (1), in which
the reception control unit
   displays a first display image (reception screen of action plan) for receiving the movement control instruction on the information terminal in response to the positional relationship not satisfying the predetermined condition, and
   restricts display of the first display image on the information terminal in response to the positional relationship satisfying the predetermined condition.

According to (4), when the relative positional relationship between the information terminal and the moving body satisfies the predetermined condition, the display of the display image for receiving the movement control instruction on the information terminal is restricted, and thus it is possible to prevent a situation in which the movement control on the moving body is performed although the safety of the surrounding environment of the moving body cannot be sufficiently confirmed.

(5) The control device according to any one of (1) to (4), in which,
in response to the positional relationship satisfying the predetermined condition, the reception control unit performs notification for prompting the user to move.

According to (5), when the relative positional relationship between the information terminal and the moving body satisfies the predetermined condition, the notification for prompting the movement of the user is performed, and thus it is possible to prevent a situation in which the movement control on the moving body is performed although the safety of the surrounding environment of the moving body cannot be sufficiently confirmed.

(6) The control device according to (5), in which
the notification includes displaying on the information terminal a second display image for prompting the user to move so as to eliminate a state in which the positional relationship satisfies the predetermined condition.

According to (6), when the relative positional relationship between the information terminal and the moving body satisfies the predetermined condition, it is possible to display on the information terminal the display image for prompting the user to move so as to eliminate the state in which the predetermined condition is satisfied. Accordingly, it is possible to prevent a situation in which the movement control on the moving body is performed although the safety of the surrounding environment of the moving body cannot be sufficiently confirmed. In addition, it is possible to have the user recognize why the reception of the instruction from the information terminal is restricted.

(7) The control device according to any one of (1) to (6), in which,
in response to the positional relationship not satisfying the predetermined condition after the reception of the movement control instruction is restricted, the reception control unit releases the restriction on the reception of the movement control instruction.

According to (7), when the relative positional relationship between the information terminal and the moving body no longer satisfies the predetermined condition after the reception of the instruction from the information terminal is restricted, the restriction on the reception is released. Therefore, the movement control on the moving body from the outside of the moving body may be appropriately restricted. In addition, it is possible to eliminate an anxiety of the user about not receiving the instruction from the information terminal.

(8) The control device according to any one of (1) to (7), in which
the reception control unit sets the predetermined condition in accordance with a surrounding environment of the moving body.

According to (8), the predetermined condition is set according to the surrounding environment of the moving body, and thus it is possible to appropriately restrict the movement control on the moving body from the outside of the moving body.

(9) The control device according to any one of (1) to (8), in which
the reception control unit displays a third display image (reception screen of movement control execution instruction) for starting the movement control on the information terminal after receiving the movement control instruction.

According to (9), by displaying on the information terminal the display image for starting the movement control after the movement control instruction is received, the operation by the user in the movement control on the moving body may be smoothly executed, and the movement control on the moving body from the outside of the moving body may be appropriately restricted.

(10) The control device according to any one of (1) to (9), further including:
a charge control unit (charge control unit 58) configured to perform charge control on a power supply device for the movement control, in which
the reception control unit displays, on the information terminal, a fourth display image (reception screen of an ignition ON instruction) for starting the moving body,
the charge control unit starts the moving body and starts the charge control based on an instruction of a user on the fourth display image, and
the reception control unit
   displays a first display image for receiving the movement control instruction on the information terminal in response to the positional relationship not satisfying the predetermined condition after the charge control is started,
   after the movement control instruction is received based on an instruction of a user on the first display image, displays a fifth display image (charge wait screen) representing a progress state of the charge control on the information terminal while the progress state does not reach a predetermined state, and,
   in response to the progress state reaching the predetermined state, does not display the fifth display image on the information terminal or displays the fifth display image on the information terminal in a mode less noticeable than a mode in which the fifth display image is displayed when the progress state does not reach the predetermined state.

According to (10), in a case where the relative positional relationship between the information terminal and the moving body does not satisfy the predetermined condition when the moving body is started according to the instruction of the user, the charge control on the power supply device is performed while the movement control instruction is received from the user, and the display image representing the progress state of the charge control is displayed after the movement control instruction is received. Therefore, it is possible to make the user feel that a time to wait for the charge control on the power supply device is short. In addition, when the progress state of the charge control on the power supply device reaches the predetermined state after the movement control instruction is received from the user, the display image representing the progress state is not displayed, thereby reducing annoyance of the user.

(11) The control device according to (10), in which
the progress state includes at least any one of a progress rate of the charge control, a time until the charge control is completed, a charge amount of the power supply device, or a charge rate of the power supply device.

These items described in (11) are preferable as the charge progress state to be notified to the user.

(12) The control device according to (10) or (11), in which
the movement control unit restricts the movement control in response to at least any one of the power supply device and the charge control being in an abnormal state

As in (12), it is preferable to set a restriction on the movement of the moving body when there is an abnormality in the power supply device or the charge control.

(13) The control device according to any one of (10) to (12), in which
the power supply device is a sub-power supply for decelerating or stopping the moving body in response to a failure occurring in a main power supply of the moving body.

As in (13), it is preferable to display the charge wait display at an appropriate timing as needed since the charge control on the sub-power supply is required when the moving body starts to move.

(14) The control device according to any one of (1) to (13), in which
the positional relationship includes a relative positional relationship between the information terminal and a movement destination in the movement control.

As in (14), it is preferable to control the reception of the movement control instruction from the information terminal when the positional relationship between the moving body at the movement destination subjected to the movement control and the information terminal satisfies the predetermined condition.

(15) A control method performed by a control device, the control device including a processor, a communication unit configured to communicate with an information terminal portable by a user of a moving body and a movement control unit configured to perform movement control on the moving body based on a movement control instruction from the information terminal, the control method including
determining, by the processor, a relative positional relationship between the information terminal and the moving body, and
restricts, by the processor, reception of the movement control instruction from the information terminal in response to the positional relationship satisfying a predetermined condition.

According to (15), the relative positional relationship between the information terminal and the moving body is determined. In a case where the positional relationship satisfies a predetermined condition, the reception of an instruction from the information terminal when the movement control on the moving body is performed by the information terminal may be restricted, and thus the movement control on the moving body from the outside of the moving body may be appropriately restricted.

(16) A non-transitory computer readable storage medium storing a control program for causing a processor of a control device to execute a process, the control device including a communication unit configured to communicate with an information terminal portable by a user of a moving body and a movement control unit configured to perform movement control on the moving body based on a movement control instruction from the information terminal, the process including:
determining a relative positional relationship between the information terminal and the moving body, and
restricting reception of the movement control instruction from the information terminal in response to the positional relationship satisfying a predetermined condition.

According to (16), the relative positional relationship between the information terminal and the moving body is determined. In a case where the positional relationship satisfies a predetermined condition, the reception of an instruction from the information terminal when the movement control on the moving body is performed by the information terminal may be restricted, and thus the movement control on the moving body from the outside of the moving body may be appropriately restricted.

What is claimed is:

1. A control device of a moving body, the control device comprising:
a communication unit configured to communicate with an information terminal portable by a user of the moving body;
a movement control unit configured to perform movement control on the moving body based on a movement control instruction from the information terminal;
a positional relationship determination unit configured to determine a relative positional relationship between the information terminal and the moving body; and
a reception control unit configured to restrict reception of the movement control instruction from the information terminal in response to the positional relationship satisfying a predetermined condition.

2. The control device according to claim 1, wherein
the predetermined condition includes a condition that is satisfied in response to a distance between the information terminal and the moving body being equal to or greater than a predetermined value.

3. The control device according to claim 1, wherein
the predetermined condition includes a condition that is satisfied in response to a shield being sandwiched between the information terminal and the moving body.

4. The control device according to claim 1, wherein
the reception control unit
displays a first display image for receiving the movement control instruction on the information terminal in response to the positional relationship not satisfying the predetermined condition, and
restricts display of the first display image on the information terminal in response to the positional relationship satisfying the predetermined condition.

5. The control device according to claim 1, wherein,
in response to the positional relationship satisfying the predetermined condition, the reception control unit performs notification for prompting the user to move.

6. The control device according to claim 5, wherein
the notification includes displaying on the information terminal a second display image for prompting the user to move so as to eliminate a state in which the positional relationship satisfies the predetermined condition.

7. The control device according to claim 1, wherein,
in response to the positional relationship not satisfying the predetermined condition after the reception of the movement control instruction is restricted, the reception control unit releases the restriction on the reception of the movement control instruction.

8. The control device according to claim 1, wherein
the reception control unit sets the predetermined condition in accordance with a surrounding environment of the moving body.

9. The control device according to claim 1, wherein
the reception control unit displays a third display image for starting the movement control on the information terminal after receiving the movement control instruction.

10. The control device according to claim 1, further comprising:
a charge control unit configured to perform charge control on a power supply device for the movement control, wherein
the reception control unit displays, on the information terminal, a fourth display image for starting the moving body,
the charge control unit starts the moving body and starts the charge control based on an instruction of a user on the fourth display image, and
the reception control unit
displays a first display image for receiving the movement control instruction on the information terminal in response to the positional relationship not satisfying the predetermined condition after the charge control is started,
after the movement control instruction is received based on an instruction of a user on the first display image, displays a fifth display image representing a progress state of the charge control on the information terminal while the progress state does not reach a predetermined state, and,
in response to the progress state reaching the predetermined state, does not display the fifth display image on the information terminal or displays the fifth display image on the information terminal in a mode less noticeable than a mode in which the fifth display image is displayed when the progress state does not reach the predetermined state.

11. The control device according to claim 10, wherein
the progress state includes at least any one of a progress rate of the charge control, a time until the charge control is completed, a charge amount of the power supply device, or a charge rate of the power supply device.

12. The control device according to claim 10, wherein
the movement control unit restricts the movement control in response to at least any one of the power supply device and the charge control being in an abnormal state.

13. The control device according to claim 10, wherein
the power supply device is a sub-power supply for decelerating or stopping the moving body in response to a failure occurring in a main power supply of the moving body.

14. The control device according to claim 1, wherein
the positional relationship includes a relative positional relationship between the information terminal and a movement destination in the movement control.

15. A control method performed by a control device, the control device including a processor, a communication unit configured to communicate with an information terminal portable by a user of a moving body and a movement control unit configured to perform movement control on the moving body based on a movement control instruction from the information terminal, the control method comprising
determining, by the processor, a relative positional relationship between the information terminal and the moving body, and
restricts, by the processor, reception of the movement control instruction from the information terminal in response to the positional relationship satisfying a predetermined condition.

16. A non-transitory computer readable storage medium storing a control program for causing a processor of a control device to execute a process, the control device including a communication unit configured to communicate with an information terminal portable by a user of a moving body and a movement control unit configured to perform movement control on the moving body based on a movement control instruction from the information terminal, the process comprising:
determining a relative positional relationship between the information terminal and the moving body, and
restricting reception of the movement control instruction from the information terminal in response to the positional relationship satisfying a predetermined condition.
